(19) United States
(12) Patent Application Publication
(10) Pub. No.: US 2021/0382377 A1
(43) Pub. Date: Dec. 9, 2021

(54) Proximity Awareness Management (PAM)

(71) Applicant: Andrew Theodore CHEN, Singapore (SG)

(72) Inventor: Andrew Theodore CHEN, Singapore (SG)

(21) Appl. No.: 17/342,521

(22) Filed: Jun. 8, 2021

Related U.S. Application Data
(60) Provisional application No. 63/035,846, filed on Jun. 8, 2020.

(51) Int. Cl. G03B 17/17; H04N 5/232; H04N 5/262; H04N 5/225; G06K 9/00

(52) U.S. Cl. CPC G03B 17/17; H04N 5/23293; G06K 9/00671; H04N 5/2254; H04N 5/2628

(57) ABSTRACT

A proximity awareness management system and method is disclosed. In particular, the system is an intelligent system integrated with an image redirector assembly to perform real-time proximity monitoring and management. The system facilitates a live view of objects in front of the user. For example, the system engages a camera of the user device through a reflective device of the image redirector assembly to allow the user to simultaneously text, type, or view applications while an accurate view is displayed on the user device, thus eliminating the need to look up. At the same time, the system is able to engage sensors of user devices as well as other devices to track events or objects around the user.

### CROSS-REFERENCE TO RELATED APPLICATION

This application claims the benefit of U.S. Provisional Application No. 63,035,846, filed on Jun. 8, 2020, which is incorporated herein by reference in its entirety for all purposes. This application also cross-references to co-pending PCT Application Ser. No. ______ entitled “Proximity Awareness Management (PAM)”, filed on Jun. 8, 2021.

### FIELD OF THE INVENTION

The present disclosure relates to monitoring, processing and alerting systems and methods. In particular, the present disclosure relates to the use of a system integrated with an image/data redirector assembly for providing proximity awareness management when a mobile device user is active and/or in motion.

### BACKGROUND

Conventional handheld devices, such as smartphones, create great distractions, impaired judgment/motor skills, and reduced awareness of a user's surroundings. This negligence caused by the divided attention and visual impairment of the user often leads to unnecessary accidents that not only harm the user but also endanger others around them. To avoid such accidents from happening on the road, most if not all jurisdictions have imposed regulations and laws to prevent the use of mobile devices while driving. However, there are no laws regulating their use while walking.

When a user is using a handheld device, the user is distracted and is less aware of the surroundings. For example, the user is generally looking downwards and focused on the device. This negatively impacts the user's ability to walk normally and safely. For example, the field of vision of the user is reduced or blocked, inhibiting the user's ability to avoid oncoming people, walk in a straight line or walk at a normal pace. Such distractions may cause numerous potential hazards. Just to name a few, the user's distraction may cause 1) the user to collide into other walkers, 2) the user to collide into objects, including vehicles, 3) others to collide into the user, 4) the user walking into hazards such as traffic. Consequently, the distractions for use of handheld devices may cause harm to the user as well as to others.

From the foregoing discussion, there is a need to enable proximity monitoring and management on mobile devices to improve awareness of users while using mobile devices for personal and community safety.

### SUMMARY

Embodiments generally relate to monitoring, processing and alerting methods and systems for proximity awareness management. In particular, the system is an intelligent system integrated with an image redirector assembly to perform real-time proximity monitoring, warnings and management to facilitate proximity awareness.

In one embodiment, an image redirector assembly for a user device includes a redirector housing configured to attach to a region on the user device surrounding a camera lens. The assembly also includes an optical reflector disposed in the redirector housing, wherein the optical reflector include an optical element The optical element is configured to selectively deploy from a first position to a second position to reflect a forward-facing view to a camera lens having a line of sight not perpendicular to the forward-facing view when the user device is tilted.

In another embodiment, a method for performing proximity management includes attaching an image redirector assembly to a region on a user device surrounding a camera lens, wherein the image redirector assembly includes a redirector housing with an optical reflector. The method also includes deploying an optical element of the optical reflector from a first position to a second position to reflect a forward-facing view to a camera lens having a line of sight not perpendicular to the forward-facing view when the user device is tilted and capturing, by the user device, inverted forward-facing images of the reflected forward-facing view. A video of the captured inverted forward-facing images in a corrected upright orientation is displayed for a user to view on the user device.

These and other advantages and features of the embodiments herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of various embodiments. In the following description, various embodiments of the present disclosure are described with reference to the following, in which:

FIG. 1 shows a user using a mobile phone;

FIG. 2a illustrates a simplified embodiment of a proximity awareness management system;

FIG. 2b is a simplified illustration of the proximity awareness App operating in an alert mode;

FIGS. 3a-3b show various embodiments of an image redirector assembly;

FIGS. 4a-4b show back and cross-sectional views of an embodiment of an image redirector assembly in the undeployed and deployed positions;

FIGS. 4c-4d show other embodiments of image redirector assemblies;

FIGS. 5a-5e show various views of another embodiment of an image redirector assembly;

FIGS. 6a-6c show various views of the image redirector assembly with the reflective optical mirror illustrated in FIGS. 5a-5e;

FIGS. 7a-7b show another embodiment of the image redirector assembly with a prism as the optical reflector;

FIG. 8 shows another embodiment of an image redirector assembly;

FIGS. 9a-9c shows yet another embodiment of an image redirector assembly;

FIG. 10 show an exemplary process of the proximity awareness system with the image redirector assembly; and

FIGS. 11a-11b show an exemplary image/data capturing process using the system with the image/data redirector assembly.

### DETAILED DESCRIPTION

Embodiments generally relate to proximity awareness management systems and methods. In particular, the system is an intelligent system integrated with an image redirector assembly to perform real-time proximity monitoring and management.

Humans can be unreliable and error-prone, mainly because of limitations in the amount of information that a human brain can process, compute and deliver to react in time. This makes it easy for accidents to happen, and in certain cases, such accidents can cost lives. This situation has also been further aggravated by the use of mobile devices which further divide the attention span of users.

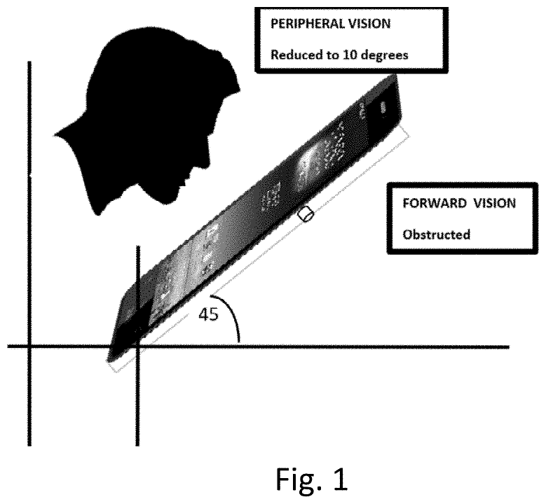

A user operating a mobile device generally exhibits reduced awareness of the general surroundings. In fact, the user's field of vision is often hindered or impeded while holding the mobile device. For example, as shown in FIG. 1, a human's 130-degree peripheral view is reduced to about 10 degrees while looking at a mobile device. This impairs a user's judgment and/or motor skills, leading to an increased chance for accidents to occur. As such, intelligent systems, including artificial intelligence (AI) systems, pose as an ideal solution to reduce risks of accidents as the systems can be programmed to execute tasks seamlessly and efficiently to provide monitoring and timely alerts of nearby obstructions, regardless of the complexity level of the tasks, and therefore avoiding potential accidents,

In one embodiment, an intelligent proximity monitoring system is provided. The system is configured to perform real-time monitoring of surrounding events or objects. By engaging sensors, such as cameras, autofocusing sensors and GPS, of the device held by the user, the system is able to track events or objects around the user. In addition, the system may be configured to enable the user device to receive and process information from other sources. The other sources may include any device capable of providing status information, including location information, movement information, speed information and other status information of other devices. For example, mobile devices of other users, such as mobile phones and vehicles, may provide location information, direction of movement information, speed information as well as other information, such as the type of device. In addition, smart city devices, such as crosswalks, signal lights and information signs, may provide relevant information, such as location and status information. The information enables the system to compute proximity information surrounding the user to identify proximate objects and evaluate whether these objects are proximate hazards. Other information which may also be provided may include information of the owners of the proximate devices. This, for example, enables the user to be informed who is in the proximate vicinity of the user, such as devices associated with friends.

As part of real-time monitoring, the system may perform, for example, supervision of a user's proximity to surrounding objects. When switched to an alert mode, the system alerts the user of detected hazards using the device's outputs, such as the audio output (e.g., speakers), the visual output (e.g., display with colors and images) and the tactile output (e.g., vibration) to gain the user's immediate response. The warning may be adjusted based on the level of risks. The higher the risk level, the more intense the warning. The level of risk may be based on the distance of the object or person to the user. The system may be configured with four risk levels, neutral, low, medium and high. The system may be configured with other numbers of risk levels. Table 1 below shows an exemplary embodiment of the level of risks based on distance.

TABLE 1

| Risk Level | Distance | Warning Intensity |
|---|---|---|
| Neutral | ≥ 10 meters | None |
| Low | ≥ 5 and | Low |
| | < 10 meters | |
| Medium | ≥ 1 and | Medium |
| | <5 meters | |
| High | < 1 meter | High |

In addition, the objects and people in the image may be overlaid with different colors to indicate the risk level of the hazard, such as neutral (none), low (green), medium (yellow) or high (red).

In one embodiment, the system is configured to facilitate a live view of objects in front of the user. For example, the system engages a camera of the user device through a reflective device of the image redirector assembly to allow the user to simultaneously text, type, or view applications while an accurate view is displayed on the user device, thus eliminating the need to look up.

With the image redirector assembly, the camera can display frontal facing images at any time without the need to reposition the user device in an upright position. A view of the live video may be displayed on the display using a multi-window or a split-screen mode. The user is therefore able to keep an eye on surrounding objects without looking up from either the user device or the task he is working on. This allows the user to multitask on the user device without comprising on safety issues.

The system advantageously provides a monitoring workflow capable of gathering massive data about the user's environment and employs AI technologies for rapid and efficient processing to achieve almost instantaneous delivery of relevant proximity information to the user. For example, AI processing techniques configured to prioritize and process data based on their relevance and correlation to the particular user are utilized by the system. Moreover, the output of a live video with proximity information provides the user with a comprehensive overview of the user's surroundings. Unlike a human brain which is only capable of gathering and processing a limited amount of information at one time, the fast turnover processing time of the system is crucial as it allows the user sufficient response time to make the right decisions and react timely to avoid collisions and/accidents.

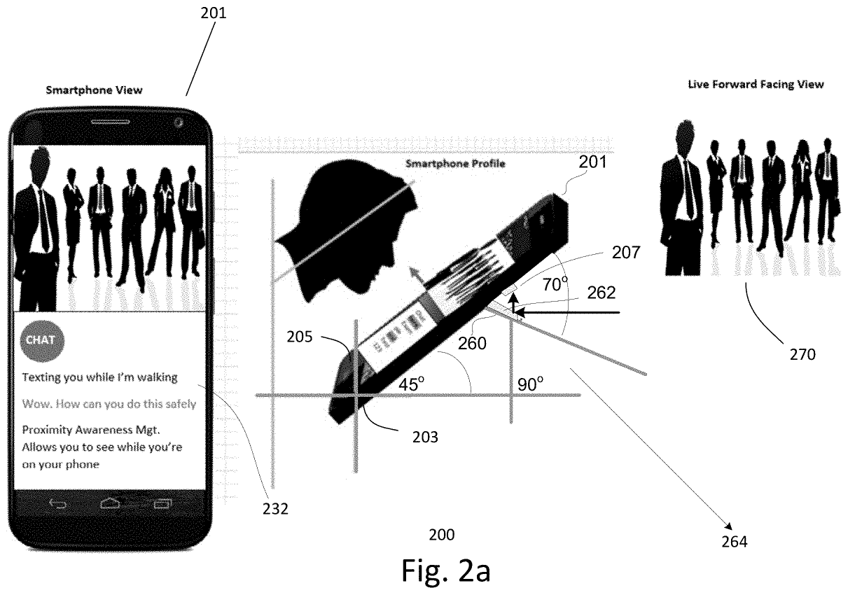

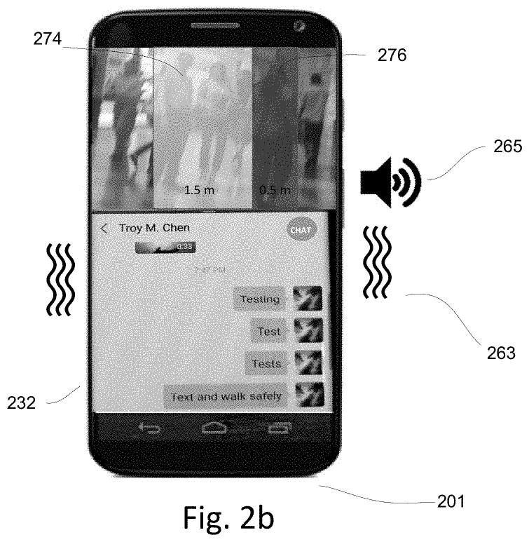

FIG. 2a illustrates a simplified embodiment of a proximity awareness management system 200. The system is configured to operate on a mobile device 201. As shown, the mobile device is a smartphone. The system may also be configured to operate on other types of mobile devices, including a dedicated or stand-alone mobile device. The smartphone includes a processor configured for running applications installed thereon, memory for storing data and applications, input and output interfaces, such as a speaker, a microphone, a vibrator to effect notifications to the user, touch screen or display, control buttons, including hard and soft control buttons for operating the phone, various connections, such as network connections, including cellular, Wi-Fi, Bluetooth and other connections. The mobile device may also be provided with other sensors, functions or features, such as GPS, gyroscopes, accelerometers, barometers, RFID, shock, LiDAR and other types of sensors.

The mobile device includes a casing having a front surface 205 and a back surface 203. The front surface includes a display 232 and control buttons while the back surface includes a forward-facing camera module. The forward-facing camera module, for example, is a built-in camera module. The camera module includes a forward-facing camera lens 207 configured with a front field of view (FOV) for capturing images in front of the user device, such as the forward-facing view 270. The camera module may include a focusing unit to focus the lens as well as a flash unit to facilitate image capturing at night. The focusing unit, for example, may be LiDAR-based or infrared-based. Other types of focusing units may also be useful.

The mobile device, in one embodiment, includes an image redirector assembly 260 mounted on the back surface of the mobile device. The image redirector assembly includes an optical reflector for directing images in the forward-facing view 270 to the forward-facing camera lens. The image redirector assembly may be an external assembly which is mounted onto the back surface of the mobile device or integrated into the back surface of the mobile device. The optical reflector of the image redirector assembly can be configured into first and second operating modes. The first operating mode is an active mode in which the optical reflector is deployed to redirect forward-facing images to the camera lens when the user is looking downwards while in motion; the second operation mode is an inactive mode in which the optical reflector is undeployed or retracted to avoid interfering with normal image capturing by the camera lens.

As shown, the user is looking at the mobile device display while in motion, such as walking. The mobile device is tilted at an angle from vertical, such as 45°. The optical reflector 261 of the image redirector assembly is deployed or positioned to reflect the forward-facing view to the camera. Without the optical reflector or having it deployed, the view that the camera would capture would be the ground at 45°, as indicated by arrow 264.

The optical reflector, in one embodiment, is an optical element configured for redirecting the forward-facing view to the camera lens when deployed. The optical element may be a mirror or a prism. The mirror may be formed of various types of reflective materials, such as flexible plastic, metal or glass. The mirror can be a fixed-angle, a curved or a fanning mirror. As for the prism, it may be a fixed-angle prism. Other types of mirrors or prisms may also be employed to serve as the optical reflector.

The image redirector assembly may include a redirector housing. The housing holds the optical reflector. The housing is configured to deploy the optical reflector for redirecting the forward-facing view or to retract the optical reflector to avoid interfering with the camera lens. The housing may be a single piece or a multi-piece housing. Various types of materials may be employed to form the housing. For example, the housing may be formed from a flexible or rigid material. Flexible materials may include plastic or rubber while rigid materials may include metal, ceramic or molded plastic.

The mobile device is configured with the proximity awareness management application (App). The App is installed and runs on the mobile device. The App, when initiated to capture the forward-facing view, controls native functions and features of the mobile device, such as the camera module, speaker and display. The App may be initiated when a user is walking and using the mobile device at the same time. Initiating the App may be done manually by the user or automatically when the mobile device senses that the user is moving. The App may query the user to choose to initiate the App or to shut off the mobile device.

When initiated, the optical reflector of the image redirector assembly is in the active mode. For example, the optical reflector is deployed or positioned to redirect the forward-facing view to the camera lens. Deploying the optical reflector may be performed manually by the user. The App may inform or instruct the user to deploy the optical reflector. In some embodiments, such as an integrated image redirector assembly, the deployment of the optical reflector may be automatically performed by the mobile device when the App is initiated.

The App causes the camera to capture a live video of the forward-facing view using the optical reflector 261 of the image redirector assembly 260. Due to the mirror effect of the optical reflector, the forward-facing view captured is reversed and upside-down of the actual forward-facing view. The App processes the video of the captured forward-facing view to correct (right-side) the view. For example, the view may be rotated 180°. Other techniques for correcting the captured view may also be useful. In addition, the App may adjust the focus of the camera to enhance image sharpness. Other types of image processing may be performed on the video.

The App displays the corrected captured forward-facing view on the display 232 of the mobile device. The corrected captured forward-facing view may be displayed using a split-screen mode. As shown, the live video of the forward-facing view is displayed on the top half of the display. The video, alternatively, may be displayed using other configurations, such as at the bottom half, at the corner, at the side of the display or in different sized windows. Displaying the forward-facing view using only a portion of the display allows the user to continue using the remaining display portion of the mobile device for other applications, such as texting, playing games or watching videos. The display of the live video serves as a heads-up display to the user, providing information related to oncoming people with minimal disruption. The user may also have the option of displaying the live video of the forward-facing view using the whole display.

As described, the proximity awareness management App provides a live forward-facing view to the user when using the mobile device while in motion. The proximity awareness management App may be configured to operate in an alert mode. In the alert mode, the App processes the video to obtain additional information regarding the people and objects therein. As used herein, objects may collectively include any objects, including people and devices of other users. Based on information obtained, the App generates warnings or alerts to the user regarding potential hazards. The warnings are generated using the mobile device's sensory outputs, such as the speaker (hearing), vibrator (touch) and display (vision) of the mobile device or a combination thereof.

The warnings can be based on identified risk level. The higher the risk level, the more intense the warning. The warnings may cease or terminate when there are no identified risks. For the hearing sensory output, the volume or decibel of the warning is higher for higher risk levels and lower for lower risk levels. In addition, the frequency, such as a beeping type warning, may increase in frequency with higher risk levels and decrease in frequency with lower risk levels. For verbal warning messages, the message may vary as to the imminence of the danger as well as with volume. Regarding the touch sensory output, the intensity and/or frequency of the vibration may be varied based on the risk level. As for the vision sensory output, the color intensity may be associated with the risk level or the intensity or frequency of the flashing of the colors may be associated with the risk level. The App may, in some embodiments, display a virtual representation identifiable with the level of risk.

The risk level, in one embodiment, is based on the distance of the proximate objects identified with respect to the user. The closer the distance an object is to the user, the higher the level of risk. For example, the App applies a graduated distance risk assessment or graduated distance warning. The distance of the objects may be determined using the focusing unit of the camera module. The focusing unit may use LiDAR, infrared, laser, sound waves or a combination thereof for focusing the camera lens. Other focusing techniques or technologies may also be employed by the camera module.

The App may be configured to access the focusing unit to identify the distance of objects captured in the video. The App may perform distance compensation on the objects due to the optical reflector. The amount of compensation may depend on the type of optical reflector used by the image redirector assembly. The compensation results in accurate distancing of the objects to the user. The risk levels may be as defined in Table 1. Other configurations of risk levels may also be used by the App.

FIG. 2b illustrates a smartphone 201 configured with a proximity awareness management App operating in the alert mode. As shown, the smartphone includes a display 232. The App is displaying the corrected forward-facing view in split-screen mode. As shown, the forward-facing view is displayed in the top half of the display while the user is using another application, such as a texting application, on the bottom half of the display.

The App identifies various objects and their distances to the user. In the warning mode, the App also provides warnings to the users according to the level of risk of each object. The level of risks is based on the distance of the object to the user, such as that described in Table 1 above. Of course, it is understood that the level of risk may be based on other distance values or other parameters. The distance of an object or object group may be displayed. As used herein, object may refer to an object or a group of objects which are similarly distanced. As shown, only objects which are identified as having low to high levels of risk have their distances displayed.

Based on the risk level, warnings or alarms may be generated by the smartphone. For example, alarms may be generated using the speaker, vibrator, display or a combination thereof. The intensity of the warnings is based on the level of risk of the object identified with the highest level of risk. The intensity of the warnings increases in intensity with higher levels of risk. For example, the App is configured with a graduated distance warning. The warning may be provided by the speaker 265 and/or vibrator 263.

As shown, the video may be color-coded based on the level of risk assigned to an object. For object 275 having a medium level of risk, it is overlaid with the color associated with that risk level, which is yellow. As for object 278, it is overlaid with red, indicating that it is a high-risk level object. To augment warning to the user, the colors of the highest identified level of risk may flash. The intensity or frequency of the flashing may be based on the level of risk.

The App may be configured to detect the speed and direction of travel of an object to enhance risk assessment. Speed and direction can be extracted by image processing techniques. In one embodiment, sequential video frames may be analyzed to identify the same objects and determine the differences in distance based on the information from the focusing unit. Based on the distance and time difference from frame to frame, the speed and direction of travel (away or towards the user) of an object can be determined. Objects traveling at high speeds towards the user may be identified as high risk even though they may be outside the distance which would be considered risky. For example, a skateboarder may be 20 meters away, but by the next frame, may be 10 meters away. By identifying such objects as high risk, the user may be prepared and pay more attention.

The App may also be configured to determine the speed and direction of travel of the user. This can be determined by accessing the mobile device's GPS and accelerometer. The speed and direction of travel of the user may be useful in risk assessment.

In other embodiments, the App may be configured to communicate with other devices, including smart devices, such as automobiles, smart buildings, signal lights, information signs, as well as the Internet to obtain additional information or input. This ability extends the user's experience beyond just the display of the device and provides additional information and actions from which the user can decide.

As an example, the ability to communicate with other user devices, for example, through a telecommunication network, Bluetooth and WiFi, the App can identify other devices which are in proximity (GPS of the devices) of the users who are friends with whom the user can decide to connect and meet. Also, being able to communicate with vehicles, the App can warn the user of a potential hazard based on the speed and direction (GPS) information of the vehicle as well as the speed and direction of travel of the user. Regarding signal lights, the App can warn the user that the signal light is green and prepare to stop.

The App may be downloaded and installed to run on the mobile device of the user. The App may perform various functions locally on the mobile device. For example, the App may process the video for displaying to the user, perform risk assessment of objects and generate warnings locally on the mobile device. For more sophisticated functions requiring significant processing power, the server or backend of the App, which may reside on the cloud, may perform. With the advent of high speed communication networks, such as 5G, real-time or near real-time performance can still be achieved.

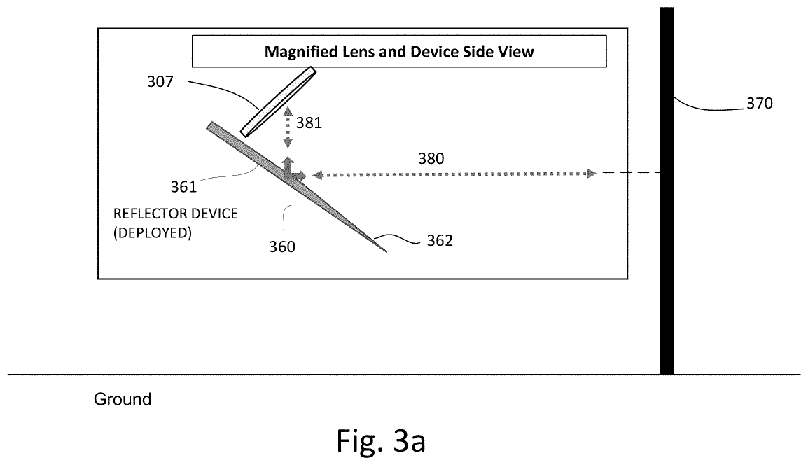

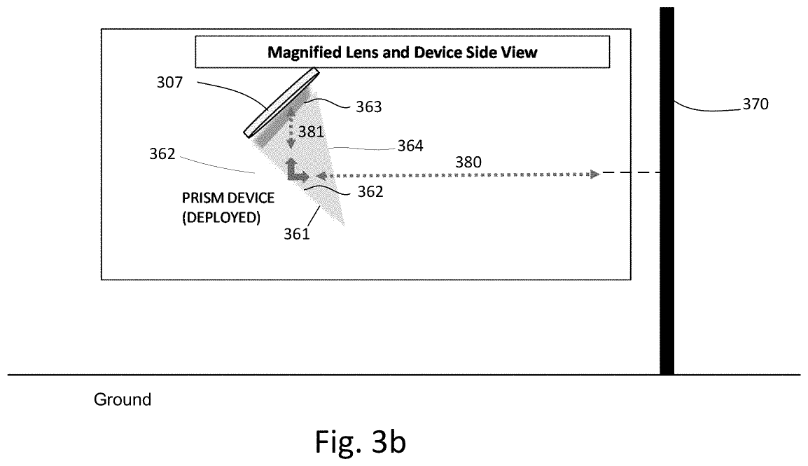

FIG. 3a shows a simplified embodiment of an image redirector assembly 360. The image redirecting assembly includes an optical reflector 361. The optical reflector includes an optical element. As shown, the optical element is a mirror with a reflective surface 362 facing towards the forward-facing view. The mirror may be formed of various materials, such as flexible plastic, metal or glass. The mirror can be a fixed-angle, a curved or a fanning mirror. Other types of mirrors can also be used to serve as the optical reflector. The angle of the deployed optical reflector is configured to redirect a forward-facing view 370 into the camera lens 307, as indicated by arrows 380 and 381. The image redirector assembly, when deployed, enables the forward-facing view to be captured by the camera lens, even the mobile device is tilted at an angle from vertical.

FIG. 3b shows another simplified embodiment of an image redirector assembly 360. The image redirector assembly includes an optical reflector 361. The optical reflector includes an optical element. The optical element, as shown, is a prism. In one embodiment, the prism is an angled prism. Other types of prisms may also serve as the optical reflector. As shown, the cross-sectional shape of the prism is a right triangle. When deployed, the hypotenuse side 364 of the prism is facing the forward-facing view 370, the first adjacent side 363 of the prism is directly over and parallel to the camera lens 307 while the second adjacent side 362 of the prism is perpendicular to the FOV of the camera lens. The hypotenuse and the first adjacent side surfaces are transparent and the second adjacent side surface is a reflective surface. In the deployed state, the optical reflector is configured to redirect a forward-facing view 370 into the camera lens 307, as indicated by arrows 380 and 381. The image redirector assembly when deployed enables the forward-facing view to be captured by the camera lens, even the mobile device is tilted at an angle from vertical.

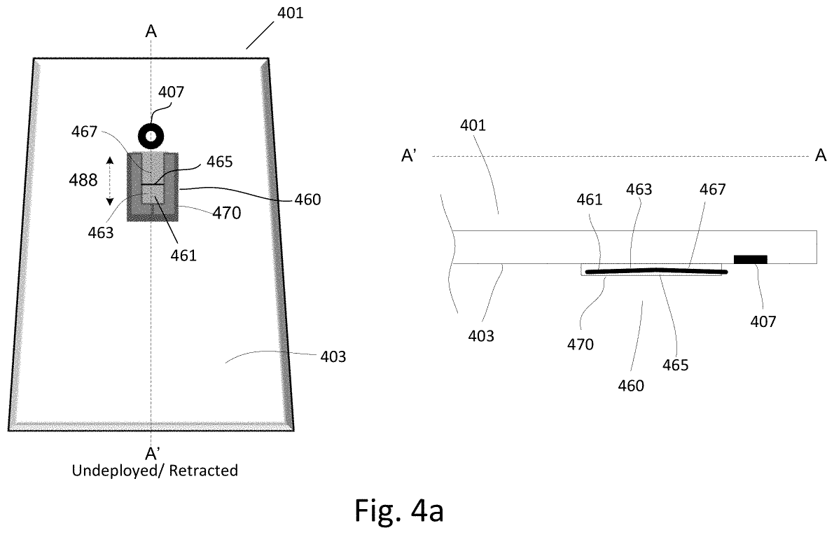

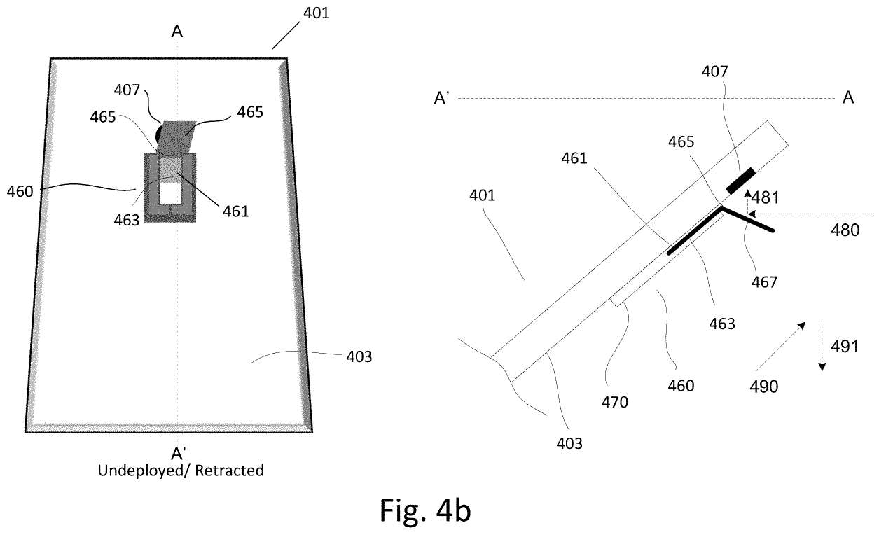

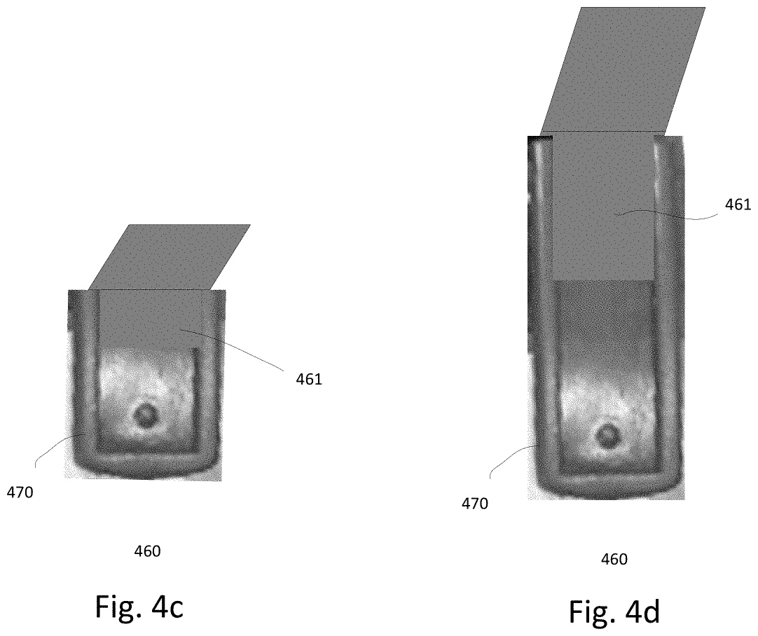

FIGS. 4a-4b show a simplified embodiment of an image redirector assembly 460 mounted on a back surface 403 of a mobile device 401. As shown, the optical reflector 461 of the image assembly is a mirror. In particular, FIG. 4a shows back and cross-sectional views along A-A′ of the device with the optical reflector undeployed and FIG. 4b shows back and cross-sectional views along A-A′ of the device with the optical reflector deployed.

Referring to FIG. 4a, the image redirector assembly 460 is mounted on the back surface 403 of the mobile device 401, such as a smartphone, in the proximity of the camera lens 407. The image redirector assembly includes a housing 470 configured to accommodate the optical reflector 461. The housing, in one embodiment, is formed of a flexible material, such as plastic or rubber. Other types of materials, such as rigid materials, may also be used to form the housing. A back surface of the housing is mounted onto the back surface of the phone. An adhesive, such as glue or double-sided adhesive tape may be used to mount the housing to the back surface of the phone.

In one embodiment, the optical reflector is a mirror. The mirror may be formed of metal, such as a stainless steel sheet, to serve as a mirror. Other types of mirrors or materials may also be used to form the mirror. For example, the mirror may be a flexible mirror coated onto a mirror base which can be configured to bend for deployment. As shown, the mirror is a rectangular-shaped mirror which is slidably contained in the housing along the length direction of the housing away and towards the camera lens, as indicated by arrow 488. In other embodiments, the mirror may have other shapes. In one embodiment, the housing has a similar shape as the mirror, such as a rectangular shape, and includes rails on sides and a closed-end thereof. The mirror may slide into the slots of the housing from the open end. As such, the housing serves as a slidable frame in which the mirror can slide along the direction parallel to the sides from the open end to the closed end, as indicated by arrow 488.

In the retracted or undeployed mode, the mirror is disposed in the housing and does not interfere with the camera's normal operation. The mirror is configured with a crease 465 or a foldable edge in a central portion thereof, separating into a base portion 463 and an extension portion 467. The crease facilitates the folding of the mirror when deployed. As shown, the mirror is slightly bent at the crease, which helps to maintain the mirror within the housing when in the undeployed position.

The thickness of the mirror is selected so that it can bend and maintain in the deployed position without breaking. In one embodiment, the thickness of the stainless steel mirror is about 0.25 mm thick. The mirror may have other thicknesses and may depend on the material of the mirror. As for the width of the mirror, it should be about 1.5 times the diameter of the camera lens while the length of the extension portion should be at least about 1.5 to 2.5 times the length of the camera lens to ensure capturing of the forward-facing view by the camera. As for the base portion, it should have a sufficient length to maintain the optical mirror into position when deployed. Other dimensions for the mirror may also be useful.

FIG. 4b illustrates the optical reflector 461 of the image redirector assembly in the deployed position. To deploy the optical reflector, it is slid out of the housing 470 towards the camera lens 407, as indicated by arrow 490. When the crease 465 exits out of the housing, the extension portion is bent downwards away from the camera lens until it is in the deployed position, as indicated by arrow 491 in the direction. In the deployed position, the extension portion is configured to direct the forward-facing view to the camera lens.

In the deployed position, the lens to redirecting surface angle may be adjusted to ensure capturing of the forward-facing view by the camera lens. The lens to redirecting surface angle may be about 45 to 135 degrees. Preferably, the lens to redirecting surface angle is about 90 degrees. Other angles may also be possible. As shown, the image redirecting surface of the extension portion is a flat surface. Providing a convex or concave surface or other types of surfaces to generate different imaging effects, such as wide-angle viewing or fish-eye viewing may also be useful.

As described, the image redirector assembly includes a housing configured to slide and accommodate the optical redirector. In other embodiment, the optical redirector may be embedded into a protective phone casing. For example, the mirror as described, may be embedded under the protective phone casing and extend out for deployment or retracted when not in use.

FIGS. 4c-4d show other embodiments of image redirector assemblies 460 with the optical reflector 461 in a deployed position. The image reflector assemblies of FIGS. 4c-4d are similar to that described in FIG. 4b. Common elements may not be described or described in detail.

The image reflector assemblies of FIGS. 4c-4d each includes a housing for accommodating a rectangular-shaped mirror 461 serving as the optical reflector. The housing 470 is a rectangular shaped housing made of flexible material such as plastic. The housing includes a back surface with side rails on the sides and an end rail at a closed end of the housing, serving as a slidable frame for the mirror along the direction of the side rails. The mirror is extended in the deployed position for capturing the forward-facing view by the camera when tilted at an angle to the ground. As shown, the housing of FIG. 4c is shorter in length than the housing of FIG. 4d. As such, the length of the mirror accommodated by the housing of FIG. 4c is shorter than the length of the mirror of FIG. 4d.

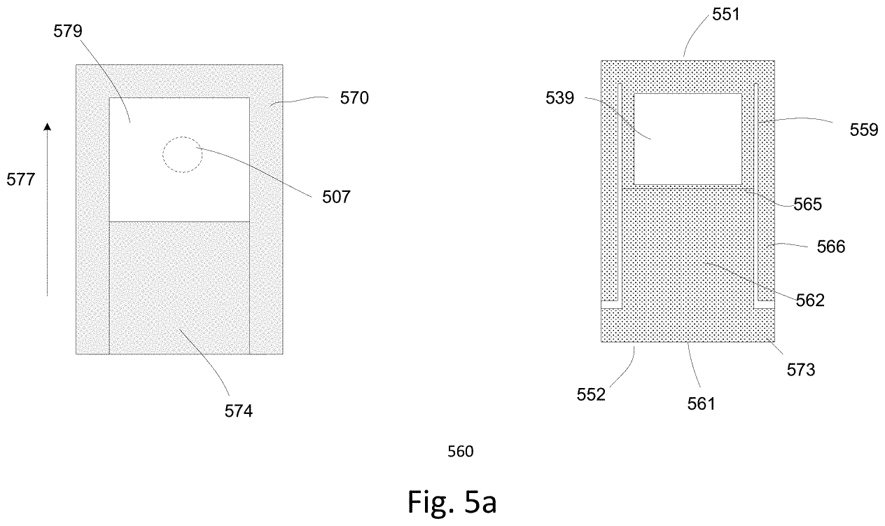

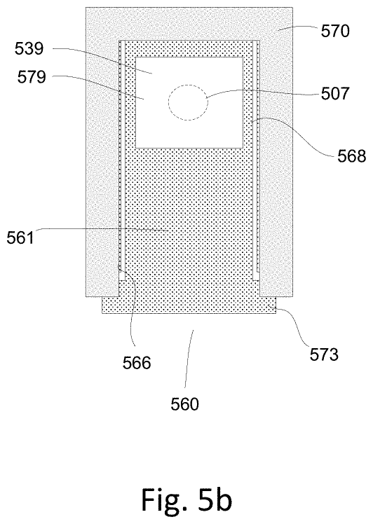

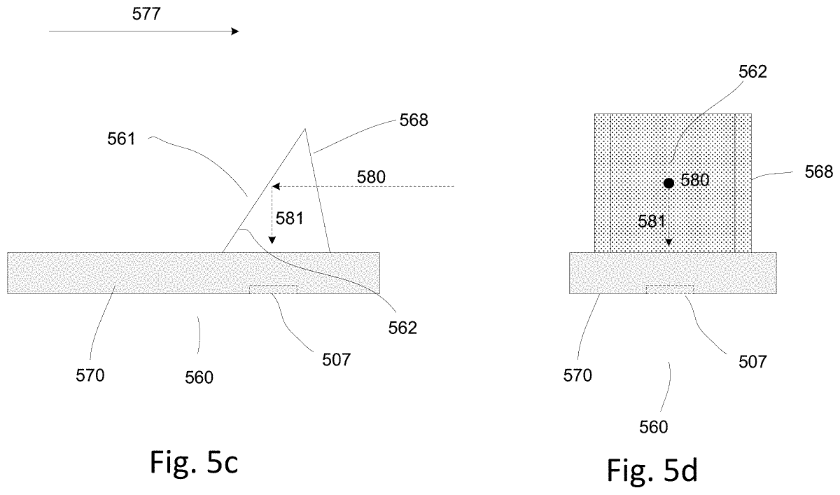

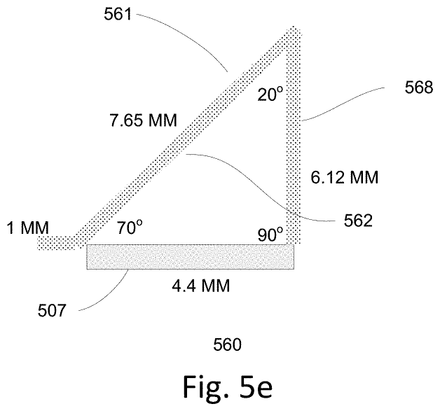

FIGS. 5a-5e show various views of another embodiment of an image redirector assembly 560. Referring to FIG. 5a, a top view of a housing 570 and an optical reflector 561 for an embodiment of an unassembled image redirector assembly is shown. In one embodiment, the optical reflector is a mirror. The mirror may be formed of metal, such as a stainless steel sheet, to serve as a mirror. Other types of mirrors or materials may also be used to form the mirror. For example, the mirror may be a flexible mirror coated onto a mirror base which can be configured to bend for deployment.

In one embodiment, the mirror is configured, when deployed, to capture forward-facing view by the camera of the mobile device, such as a smartphone. As shown, the rectangular-shaped mirror includes first and second opposing sides along the length of the mirror and first and second opposing ends 551 and 552 along the width of the mirror. The first end may be referred to as an insertion end while the second end may be referred to as a tail end. The mirror includes a rectangular-shaped mirror void 539 disposed proximate to the insertion end. The mirror includes first and second side separations 559 along first and second sides of the mirror. The side separations are partial separations which extend most of the length of the mirror. A first end of the separations starts near the insertion end and a second end of the separations terminates near the tail end. The second end of the separations extends to the sides of the mirror. The separations form first and second mirror rails 566 along the sides of the mirror. A central portion of the mirror separated by the mirror rails serves as the reflective surface 562 of the mirror. At the tail end of the mirror are mirror feet 573, one foot on each side. The central portion is configured with a crease 565 to facilitate folding the mirror. The sides of the voids serve as support for the reflective surface when deployed. In addition, the void provides an opening, enabling the forward-facing view to be captured by the camera.

The housing is configured to accommodate the optical reflector 561 of the image redirector assembly. As shown, the housing is a rectangular-shaped housing configured to accommodate the rectangular-shaped mirror. The housing includes a back surface 574. The back surface includes a housing void 579 to expose a camera 507 of the mobile device when mounted on the back surface thereof. Mounting the back surface of the housing to the mobile device can be achieved using an adhesive, such as glue or double-sided adhesive tape. The front surface includes railings on the sides and the closed end of the housing. The closed end of the housing is proximate to the void. The front surface railings form a frame in which the mirror can slide into the housing from the open end until it reaches the closed end, as indicated by arrow 577. In other embodiments, the housing may have a U-shape in which the front and bottom surface includes railings on the sides and at the closed end. The housing, in one embodiment, is formed of a flexible material, such as plastic or rubber. Other types of materials, such as rigid materials, may also be used to form the housing.

FIG. 5b shows an embodiment of an image redirector assembly 560 with the optical reflector 561 and housing 570, as described in FIG. 5a. Common elements may not be described or described in detail. As shown the optical reflector is in the retracted or undeployed state. The optical reflector is inserted through the open end of the housing insertion end first and slides through until the insertion end reaches the closed end. When mounted onto the mobile device, such as the smartphone, the camera is exposed due to the housing and mirror voids 579 and 539. As shown, the tail end of the mirror with the mirror feet 573 extends through the open end of the housing. The mirror and housing may have other configurations.

FIGS. 5c-5d show side and front views (as viewed from the forward-facing view towards the mobile device) of the image redirector assembly 560 of FIGS. 5a-5b with the optical reflector 561 deployed. Common elements may not be described or described in detail. To deploy the optical reflector 561, the mirror is slid along the direction towards the camera, as indicated by arrow 577. In one embodiment, the feet of the mirror at the tail end are placed over the side rails. As the tail end is pushed along the rails of the housing, the support arms 568 at the sides of the mirror void and the reflective surface 562 of the mirror rise until the optical reflector is deployed. The housing void allows the camera to be exposed while the mirror void between the support arms 568 allows the forward-facing view to be unblocked and reflected by the reflective surface to the camera, as indicated by arrows 580 and 581.

FIG. 5e shows an embodiment of a simplified profile of the image redirector assembly 560 of FIGS. 5a-5d with the optical reflector 561 deployed. As shown, the lens 507 of the mobile device is configured with a 4.4 MM diameter. When the optical reflector is deployed, it forms a right triangle above the lens. The support arms 568 forms an adjacent side which is perpendicular (90°) to the FOV of the lens. The reflective surface 562 of the optical reflector forms the hypotenuse of the right triangle. The reflective surface forms a 70° angle with the lens and a 20° angle with the support arms. The length of the support arms is about 6.12 MINI while the length of the reflective surface is about 7.65 MM.

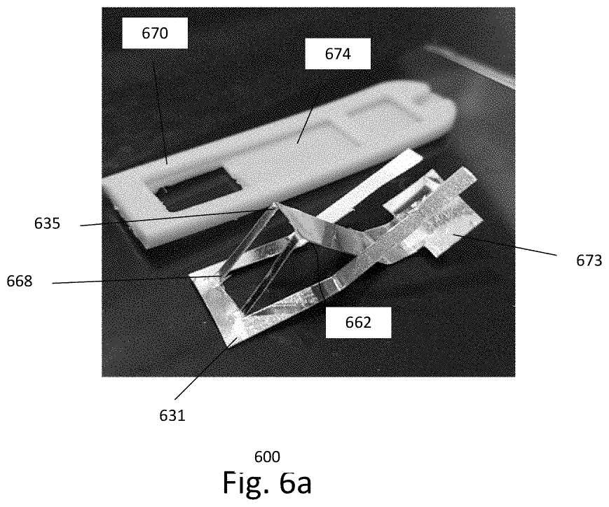

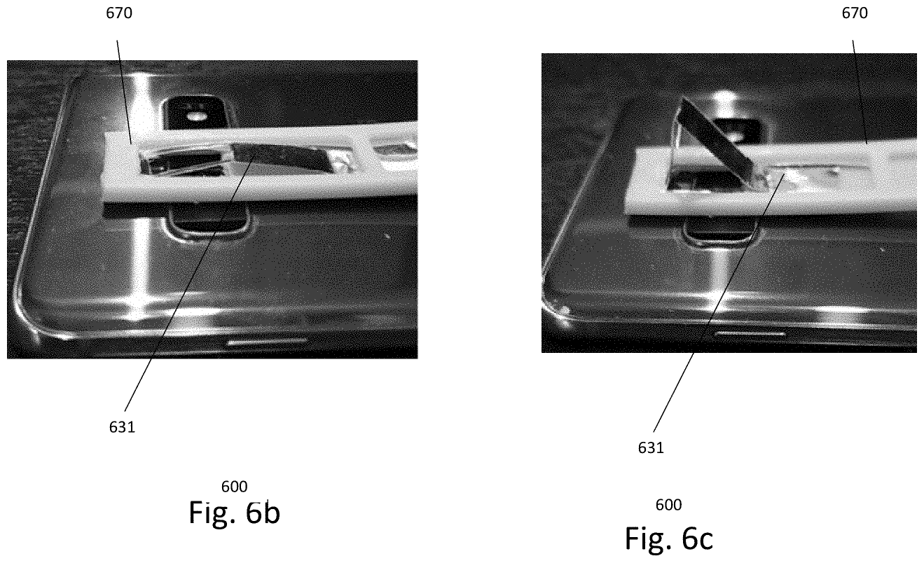

FIGS. 6a-6c show various views of the image redirector assembly 600 with an optical reflector 631 which are similarly illustrated in FIGS. 5a-5e. Common elements may not be described or described in detail. In particular, FIG. 6a shows a rectangular housing 670 and the optical reflector 631 when the assembly is disassembled. FIG. 6b shows a front view of the image redirector assembly 600 with the optical reflector 631 retracted in the housing while FIG. 6c shows a side view of the image redirector assembly 600 with the optical reflector 631 deployed. As shown, the length of the housing may be longer than the housing shown in FIGS. 5a-5e.

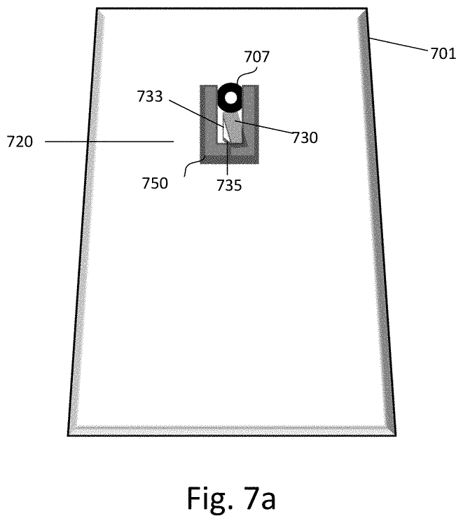

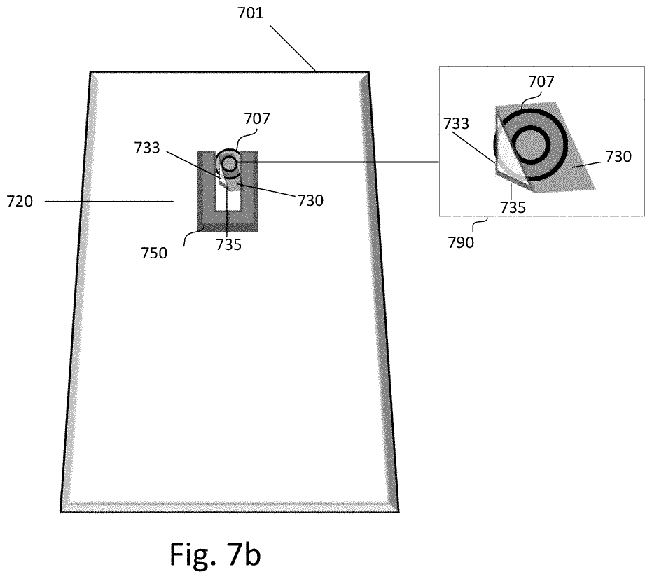

FIGS. 7a-7b show another embodiment of an image redirector assembly 720 with a prism 730 mounted on a back surface of the user device 701. In particular, FIG. 7a shows the prism 730 retracted away from the camera lens 707 while FIG. 7b shows the prism 730 deployed in front of the camera lens 707.

In one embodiment, the assembly 720 includes a housing 750 with a prism 730. The housing may be similar to any of those described in FIGS. 2a, 4a-4e, 5a-5e, and 6a-6c. For example, the optical housing can be a frame housing, or a housing plate body with or without a housing void. Other configurations of the housing may also be possible. Common elements will not be described.

In FIG. 7a, the prism 730 is positioned below the camera lens 707. For example, the prism is retracted away from the camera lens when not in use. During deployment, the prism moves in a sliding motion towards the camera lens. For example, in FIG. 7b, the prism slides over and covers the camera lens. As shown in a magnified view 790, the hypotenuse side of the prism is facing the forward-facing view, the first adjacent side 733 of the prism is directly over and parallel to the camera lens 707 while the second adjacent side 735 of the prism is perpendicular to the FOV of the camera lens. The hypotenuse and the first adjacent side surfaces are transparent and the second adjacent side surface is a reflective surface. In the deployed state, the optical reflector is configured to redirect a forward-facing view into the camera lens 707. The image redirector assembly when deployed enables the forward-facing view to be captured by the camera lens, even the mobile device is tilted at an angle from vertical. Providing other configurations or other types of prisms to generate different imaging views or effects may also be useful.

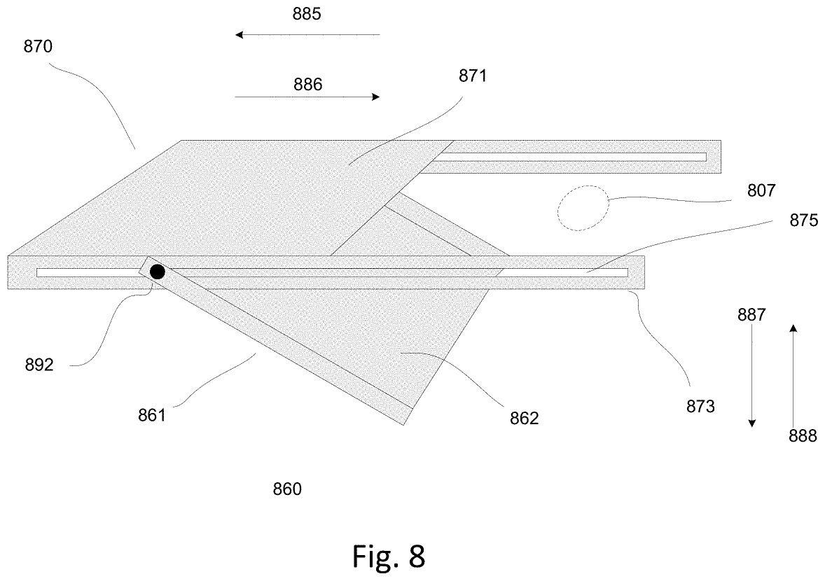

FIG. 8 shows a simplified view of another embodiment of an image redirector assembly 860. The image redirector assembly includes a housing 870. The housing, in one embodiment, includes a rectangular-shaped housing base plate 871. The housing base plate may also be configured with other shapes. The surface of the base plate is configured to mount on a back surface of a mobile device, such as a smartphone. The surface of the base plate may be configured for mounting onto other types of mobile devices. An adhesive, such as glue or double-sided tape may be used to mount the base plate to the mobile device. Other techniques for mounting the base plate to the mobile device may also be used.

The sides of the base plate each includes a base plate rail 873. For example, a first side of the base plate includes a first base plate rail and a second side of the base plate includes a second base plate rail. As shown, a base plate rail starts at one end of the side of the base plate and extends beyond the other end of the side. A top edge of the base plate rail is flushed with the surface of the base plate. When mounted onto the mobile device, the camera is located in the area between the rails.

A base plate rail includes a rail slot 875 along the length thereof. The rail slots of the base plate rails are configured to accommodate an optical reflector 861. The optical reflector, as shown, includes a reflector plate with side reflector rails configured to mount to the base plate rails. The reflector rails may extend slightly beyond the ends of the reflector plate proximate to the mounting point of the reflector rails. Mounting hinges 892 may be employed to mount the reflector plate to the side reflector rails. The hinges are configured to enable the reflector plate to slide along the base rail slots as well as rotating around an axis of the hinges. The hinges may be locking hinges. For example, when the hinges are locked, the reflector plate is immobilized. To more the reflector plate, the hinges are released.

The surface facing the housing serves as the reflective surface 862 of the optical reflector. In one embodiment, the reflective surface is a mirrored surface. When deployed, the reflective surface is configured to enable the camera to capture a forward-facing view even though the mobile device is tilted at an angle with respect to the ground.

To deploy the optical reflector, the reflector plate is rotated downwards, as indicated by arrow 887 and moved forward along the slots of the housing rail towards the camera, as indicated by arrow 886. When the reflector plate is in the deployed position, the hinges are locked, immobilizing it. To retract the optical reflector, the hinges are released and moved away from the camera, as indicated by arrow 885, and rotated upwards, as indicated by arrow 888. When the reflector plate is fully retracted, the hinges are locked.

The housing and the optical reflector may be formed of a rigid material, such as metal, ceramic, hard plastic or other rigid materials. Other types of materials, including non-rigid materials may also be used to form the housing.

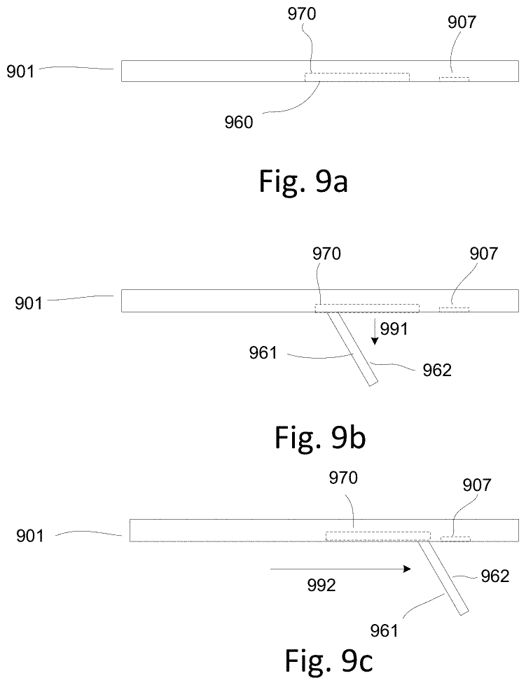

FIGS. 9a-9d show the sequence of deploying another embodiment of an image redirector assembly 960. Referring to FIG. 9a, the image redirector assembly 960 is integrated into the body of the mobile device 901, such as a mobile phone. As shown, the integrated image redirector assembly is in a retracted state. For example, the hosing 970 and optical reflector are disposed completely inside the body of the mobile device.

In FIG. 9b, the deployment of the optical reflector 961 commences. The optical reflector is released, allowing it to rotate downwards away from the back surface of the mobile device, as indicated by arrow 991. The reflective surface 962 of the optical reflector is facing the mobile device

Referring to FIG. 9c, the optical reflector 962 is moved towards camera 907, as indicated by arrow 992. When the optical reflector is fully deployed, the optical reflector is locked into position. The process is reversed to retract the optical reflector.

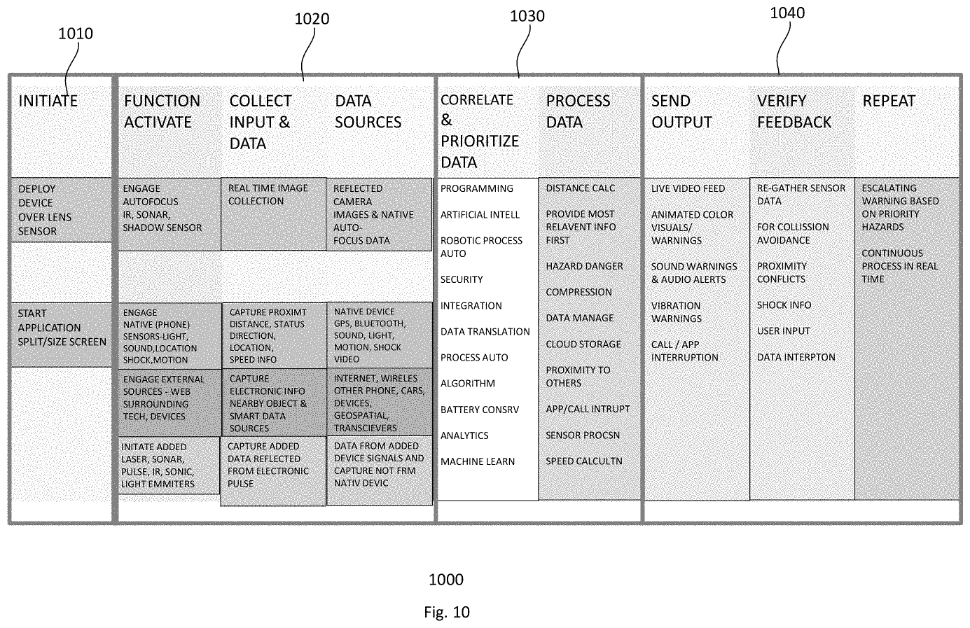

FIG. 10 shows an exemplary monitoring process 1000 of the system with the image redirector assembly. As shown, the process 1000 begins at 1010. For example, at 1010, a user initiates an App running on a user device to start a monitoring process. The monitoring process, in one embodiment, is configured to perform real time monitoring of proximate objects or targets around the user. When launched, the App may operate simultaneously with other existing running applications on the user device. For example, the user may select to view the App in a split screen view mode. A window view of the App can be displayed along with other open applications running on the user device as a top, bottom or side by side layout.

The user device may include, for example, an image redirector assembly of the system. The image redirector assembly is mounted on a back surface of the user device and is configured to enable the user device to capture look up images. At 1010, the assembly is activated in a standby mode. For example, an optical reflector of the assembly is deployed over a camera lens of the user device to standby for image capturing. Deployment of the optical reflector may be performed manually or automatically. For example, the system may control the automatic deployment of the optical reflector when the App is initiated.

In 1020, the system gathers information from various sources. The system, for example, may engage sensors of the user device, as well as other external devices to collect information. For example, the App can access the user device's sensors to collect data including user information such as the user's locations, positions, motions, and directions. For example, in the case of images and/or videos, the backend portion of the system may operate the user device's cameras, light sensors, LiDAR sensors, depth sensors and other sensors via the App to perform image capturing.

During image capturing, the deployed optical reflector is configured to enable the user device to capture look up images when tilted or when the user is using the user device. For example, the user device does not have to be positioned in an upright position so that a line of sight (LOS) of the camera lens is aligned horizontally to capture a look up image. Instead, the image redirector unit reflects an inverted look up image to the camera lens of the user device. The reflected inverted look up image is captured by the camera sensors and sent to the system for processing. A series of inverted look up images is sent for processing.

Other types of information may also be collected from the user device. The App, for example, may exploit features such as Wi-Fi, Bluetooth, and other communication networks of the user device to detect and connect with nearby external client devices to gather surrounding objects or targets data. Alternatively, data may be obtained from other external devices in direct communication with the system. Other types of sources may also be useful. For example, other sources may include the Internet.

Information collected from the various sources is streamed as input data into the the system. The Application receives the input data from the various sources and processes it.

At 1030, input data is processed by, for example, the system. In one embodiment, input data is preprocessed by the data processor. In the case of images and/or videos, the data processor will right-side an image because the original reflected image is reverse and upside-down. Image enhancement such as adjusting an image orientation, color correction, brightness correction, sharpening and/or filtering may be performed. For example, the images may be tagged with information, such as sequences in the series of frames, location, source, time stamp, as well as other required information.

The system processes data according to its relevance to a current status of the user to facilitate real time object detection and tracking. The processor identifies a current location, position, speed, and direction of the user based on user information. The processor then evaluates other data with correlations to the current user status to identify relevant data. AI processing tools which utilize machine learning algorithms or other computational techniques may be employed to identify relevant data. Relevant data, for example, may include information such as locations, positions, motion data of targets or objects around the user. Other information such as weather conditions, traffic data and other types of information associated to a user's current location may also be possible. Identified relevant data may be prioritized for processing including analysis, and/or subsequent outputting to the user.

In one embodiment, analytics is performed on, for example, prioritized relevant data. For example, the system computes and determines user proximity information based on the relevant data. Computational techniques to, for example, calculate speeds and directions of surrounding targets or objects as well as distances between the objects and the user may be employed. A distance of a target from the user may be estimated based on reference points set in a field of view (FOV) of the user device's camera during autofocusing calibration. Alternatively, directional vector calculations based on positional coordinates may also be performed. Employing other computational techniques may also be useful. As for speed, it can be obtained from calculated distance over time, where time can be based on time stamps of images or videos recorded over a specific interval. In addition, consecutive images or image frames may be used to determine a moving direction of a target. For example, a moving direction can be identified based on historical trajectories of the moving object constructed across the sequential images. Other types of analytics may also be performed. For example, analytics may be performed to predict, identify, or infer threats, anomalies, and issues.

The system may also process images by tagging the images with dynamic content or information based on real time results, such as relevant data and proximity information, generated by the system. For example, positions, speeds, directions, distances, and types of objects may be indicated in text, graphics, and/or sounds in the live videos. Other forms of tagging real time results in the live video may also be possible.

The system outputs results generated from the data processing in 1040. For example, an output interface of the Application facilitates to generate outputs to notify the user. The outputs may include a processed live video with look up image frames, proximity information, relevant data, warnings, or a combination thereof. The user, for example, is able to view a processed live video on a screen of the user device. In the case of warnings, they may include sounds, vibrations, visual cues and/or even corrective or preventive orders to gain the user's attention and/or responses.

As discussed, the monitoring process is a real time monitoring, processing and alerting process to track proximate objects or targets around the user. For example, the system is configured to detect, verify and update any changes to the user surroundings almost instantaneously through the real time input feeds and processing at the backend portion. As an example, the system detects any changes to an approaching object that may pose as a proximity hazard and generates gradual or graded warning alerts according to levels of closing proximity. As a result, output to the user can be continuously updated based on real time feedback from various sources.

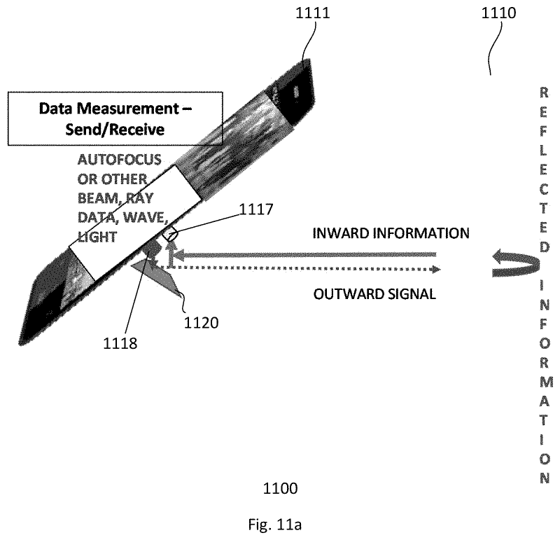

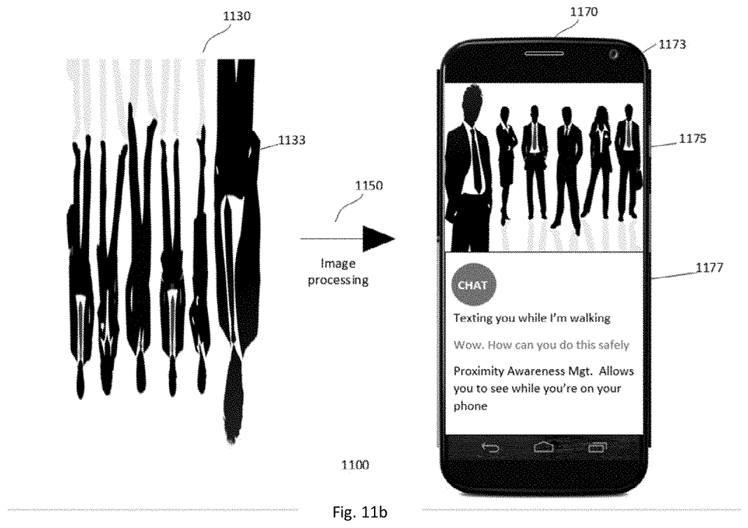

FIGS. 11a-11b show distances, sensor data and autofocusing process 1100 of using the monitoring system with the image redirector assembly.

As shown in 1110, the image redirector assembly is mounted on a back surface of the user device 1111 with the optical reflector 1120 deployed over a camera lens 1117. During image capturing, the system engages the sensors of the user device to capture inverted look up images reflected from the deployed optical element. For example, in addition to camera sensors, the system may also employ other sensors 1118 such as light sensors, LiDAR sensors, depth sensors and/or other types of sensors during the image capturing process to generate good quality images or image frames.

In 1130, inverted image frames 1133 of a live video are captured by the user device and input to the system for processing in 1150. For example, the inverted image frames are processed by the system. The system determines, for example, if image enhancement processing is required. In the case of inverted image frames, they are rotated to a correct viewing orientation. Other image enhancements may also be included. Other processing processes may also be performed.

In 1170, a processed video 1175 with corrected image frames is output to the user device 1173 for the user to view. The video can be displayed as, for example, a top window view above another open application 1177 running on the user device. The user is therefore able to keep an eye on surrounding objects without looking up from the user device. This allows the user to multitask using the user device without comprising on safety issues. Other layouts for displaying the window view of the live video may also be possible.

The inventive concept of the present disclosure may be embodied in other specific forms without departing from the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

1. An image redirector assembly for a user device comprising:
a redirector housing, the redirector housing is configured to attach to a region on the user device surrounding a camera lens; and
an optical reflector disposed in the redirector housing, wherein the optical reflector comprises an optical element, the optical element is configured to selectively deploy from a first position to a second position to reflect a forward-facing view to a camera lens having a line of sight not perpendicular to the forward-facing view when the user device is tilted.

2. The assembly of claim 1 wherein the optical element is a reflective optical mirror.

3. The assembly of claim 2 wherein when the optical element is deployed to the second position, the optical mirror is positioned over the camera lens in a folded configuration and a redirector surface of the optical mirror faces the camera lens at an angle of between 45 to 135 degrees.

4. The assembly of claim 2 wherein the optical element unfolds to form a flat configuration that is planar with the redirector housing when the optical element is retracted to the first position.

5. The assembly of claim 1 wherein the optical element is a prism.

6. A method for performing proximity management comprising:
attaching an image redirector assembly to a region on a user device surrounding a camera lens, wherein the image redirector assembly includes a redirector housing with an optical reflector;
deploying an optical element of the optical reflector from a first position to a second position to reflect a forward-facing view to a camera lens having a line of sight not perpendicular to the forward-facing view when the user device is tilted;
capturing, by the user device, inverted forward-facing images of the reflected forward-facing view; and
displaying a video of the captured inverted forward-facing images in a corrected upright orientation for a user to view on the user device.

7. The method of claim 6 wherein the optical element is a reflective optical mirror.

8. The method of claim 7 further comprising
configuring the optical mirror in a folded configuration when deployed to the second position, wherein the deployed optical mirror is positioned over the camera lens and a redirector surface of the deployed optical mirror faces the camera lens at an angle of between 45 to 135 degrees.

9. The method of claim 7 further comprising
retracting the optical mirror to the first position in a flat configuration that is planar with the redirector housing when the optical mirror is retracted to the first position.

10. The method of claim 6 further comprising
receiving input from different data sources, wherein the input includes the forward facing images captured by the user device;
processing the input, wherein processing the input comprises
identifying relevant data correlated to user surroundings, and
computing user proximity information; and
sending warnings to the user device based on results generated from processing the input.
